(19) United States
(12) Patent Application Publication
(10) Pub. No.: US 2009/0269520 A1
(43) Pub. Date: Oct. 29, 2009

(54) HEAT-SENSITIVE TRANSFER IMAGE RECEIVING SHEET

(75) Inventors: Yoshio Ishii, Kanagawa (JP); Kazuma Takeno, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, MINATO-KU TOKYO (JP)

(21) Appl. No.: 12/064,536

(22) PCT Filed: Aug. 22, 2006
(86) PCT No.: PCT/JP2006/316808

§ 371 Date: Feb. 22, 2008

(30) Foreign Application Priority Data
Aug. 23, 2005 (JP) 2005-241210
Aug. 23, 2005 (JP) 2005-241215

(51) Int. Cl. B41M 5/382; B41M 5/50

(52) U.S. Cl. 428/32.39

(57) ABSTRACT

A heat-sensitive transfer image receiving sheet that is provided in a form of a roll sheet, which comprises a mark formed in the vicinity of the defective portion, so that a printer to detect the presence of a defective portion.

### TECHNICAL FIELD

The present invention relates to a heat-sensitive transfer image receiving sheet and, particularly, to a lengthy heat-sensitive transfer image receiving sheet that is suitable to continuous processing and that can be processed continuously even if it has a defective portion or a joint part.

### BACKGROUND ART

Various image thermal transfer methods have been known. For instance, in one method, a heat-sensitive transfer image sheet (hereinafter also referred to as an ink sheet) containing dyes is overlapped on a heat-sensitive transfer image receiving sheet (hereinafter also referred to as an image receiving sheet) having a dye receiving layer formed on a dye transfer-receiving material, and then, the ink sheet is heated by a thermal head of a printer, to form an image on the image receiving sheet.

As to this image receiving sheet, usually lengthy thermal (heat-sensitive) transfer image receiving sheets, of 50 m or more in length are shipped in a roll form from makers thereof and are used for digital photo printers installed, for example, at photo shops. When, for example, a lengthy sheet 50 m in length is shipped in a roll form, an unprocessed sheet is cut every 50 m while being wound in a roll form to obtain products in a process of producing the image receiving sheet.

In lengthy ink sheets that are stored and used in a roll form, an attempt is made to provide a means that enables a printer to know that an inferior screen unit is defective in the area or the vicinity of a transfer layer corresponding to the inferior screen unit including an inferior transfer layer part, to pass over the inferior screen unit, thereby avoiding the occurrence of a defective screen (see Japanese Patent No. 2792599). However, when a defective portion is present in the middle of the lengthy image receiving sheet, and even if it is one having an area not exceeding one photographic print, the whole lengthy sheet corresponding to 500 or more photographic prints, must be scrapped, posing a non-negligible problem concerning productivity.

Also, in manufacturing the lengthy image sheet when the final region including the end of an unprocessed sheet carried from the preceding step does not reach the prescribed position that is less than 50 m distant from the start position, all of the remainder sheet must but be scrapped as a shorter product even if the shortage of the length is small, posing a non-negligible problem concerning the productivity of a lengthy heat-sensitive transfer image receiving sheet at the production line of the maker.

Also, when a defective portion is present in the middle of the lengthy heat-sensitive transfer image receiving sheet and even if it is one having an area not exceeding one photographic print, the whole lengthy sheet corresponding to 500 or more photographic prints cannot but be scrapped, posing the same problem as above at the production line. In a lengthy ink sheet that is wound like a roll to store and use, on the other hand, an attempt is made to cut off a unit transfer layer including a defective transfer layer and to join the cut-off parts with each other (see Japanese Patent No. 2576957). In this method, there is the description that detection marks are attached. However, these marks are attached to transfer layers to recognize completion of image printing with a set of the colors: yellow (Y), magenta (M), cyan (Cy), and black (Bk), for a printer, but they are not marks showing any joint parts. For example, the mark of the black makes a printer recognize that one set of printing of color image is finished and the yellow image printing for the next set of colors comes.

Also, when an image receiving sheet has the joint parts as it is, image defects arise at these joint parts when an image is formed in a printer and also an ink ribbon is damaged.

### DISCLOSURE OF INVENTION

The inventors found that an image can be formed while avoiding a defective portion by forming a detection mark in the vicinity of the defective portion existing in an image receiving sheet to enable the printer part to detect the defective portion. The inventors also found that scrap sheets are joined with each other and a detection mark is disposed in the vicinity of the joint part to thereby enable a printer part to detect the joint part and to evade only the joint part, whereby an image can be formed. The present invention was thus attained based on these findings.

According to the present invention, there is provided the following means:

(1) A heat-sensitive transfer image receiving sheet that is provided in a form of a roll sheet, which comprises a mark formed in the vicinity of a defective portion, so that a printer detects the existence of the defective portion.

(2) A heat-sensitive transfer image receiving sheet that is provided in a form of a roll sheet, which comprises a joint parts and a mark formed in the vicinity of the joint part, so that a printer detects the existence of the joint part.

(3) The heat-sensitive transfer image receiving sheet according to (2), wherein the joint part is a part in which an end part of an unprocessed sheet is joined with an end part of another unprocessed sheet.

(4) The heat-sensitive transfer image receiving sheet according to (2), wherein the joint part is a part obtained by removing a region including a defective portion present in an unprocessed sheet and then by joining the cut surfaces which are in contact with the front side and backside of the removed region respectively with each other.

In the present invention, the vicinity of the defective portion implies inclusion of the defective portion, and the vicinity of the joint part implies the inclusion of the joint part.

Other and further features and advantages of the invention will appear more fully from the following description.

### BRIEF DESCRIPTION OF DRAWINGS

FIG. 1 is a schematic view of one embodiment of the lengthy heat-sensitive transfer image receiving sheet.

FIG. 2 is an explanatory drawing showing one example of a process of producing a lengthy heat-sensitive transfer image receiving sheet according to the present invention.

FIG. 3 is an explanatory view drawing another example of a process of producing a lengthy heat-sensitive transfer image receiving sheet according to the present invention.

### BEST MODE FOR CARRYING OUT INVENTION

In an embodiment of the present invention, the lengthy heat-sensitive (thermal) transfer image receiving sheet that is provided in a form of a roll sheet, which comprises a mark formed in the vicinity of a defective portion, so that a printer detects the existence of the defective portion. As the image receiving sheet before the mark is formed, those which are currently used as the heat-sensitive transfer image receiving sheet and have a defective portion in the middle thereof may be all used. For example, sheets formed with a receptor layer made of polyethylene on a support made of coated paper may be used. Also, the lengthy heat-sensitive transfer image receiving sheet may be produced using the method of producing a lengthy heat-sensitive transfer image receiving sheet which method has been currently used, without any modification of the method except for a process of forming the mark.

The mark formed in the vicinity of the defective portion disposed on the lengthy heat-sensitive transfer image receiving sheet of the present invention may be formed at one position or plural positions in the sheet. Also, one or plural marks may be formed for one defective portion. Only one mark may be formed for plural defective portions. When plural defective portions are present in one screen after an image is formed, they may be collectively controlled by one mark.

When an image is formed in the area including a defective portion on the lengthy heat-sensitive transfer image receiving sheet of the present invention by thermal transfer using a printer, this brings about such a disorder that image defects are caused. Therefore, at photo shops the mark that enables the printer to detect the presence of the defective portion is formed in the vicinity of the defective portion in order not to form an image on the defective portion. Examples of the mark that enables the printer to detect the presence of the defective portion include, but are not particularly limited to, marks (for example, dots, lines, signs, symbols and figures) formed on the front side and/or backside of the image receiving sheet by printing using, for example, an ink-jet printer, label printer, laser marker, marking device, marking press or portable printer and punch holes that can be produced by punching these marks in the image receiving sheet. It is only required for these marks to be detected by a printer and it is not always necessary that these marks be recognized by the human naked eyes.

As to the position at which the means that enables the printer to detect the presence of the defective portion is to be disposed, the means is preferably formed at a position within 10 mm to 20 mm distant from the nearest defective portion. The means is preferably formed at a position preceding the defective portion in moving sheet at a digital photo printer.

Examples of the cause of the generation of the defective portion which can be evaded in the present invention include, but are not limited to, stains, defects of structural materials of the image receiving sheet and scratches.

In another embodiment of the present invention, the lengthy heat-sensitive (thermal) transfer image receiving sheet that is provided in a form of a roll sheet, which comprises a joint part and a mark formed in the vicinity of the joint part, so that a printer detects the existence of the joint part. As the unprocessed sheet used to form an image receiving sheet excluding the joint part and the means that enables a printer to detect the joint part, those which are currently used as heat-sensitive transfer image receiving sheets may be all used. For example, a sheet obtained by forming a receptor layer made of polyethylene on a support made of coated paper may be used.

The joint part of the lengthy heat-sensitive transfer image receiving sheet of the present invention may be provided at one position or plural positions. However, when plural joint parts are present, the interval between the joint parts adjacent to each other is preferably 200 mm or more.

In a preferred embodiment of the present invention, the joint part is a part in which the end part of an unprocessed sheet is joined with the end part of another unprocessed sheet. In this case, though no particular limitation is imposed on a method of joining these ends with each other, these ends may be joined with each other by thermal welding or thermal fusion.

The unprocessed sheet may be a shorter sheet about 10 m to 20 m in length. These shorter sheets may be plurally joined with each other to produce a lengthy heat-sensitive transfer image receiving sheet.

In another preferred embodiment of the present invention, the joint part is a part obtained by removing a region including a defective portion present in an unprocessed sheet and then by joining the cut surfaces which are in contact with the front side and backside of the removed region respectively with each other. No particular limitation is imposed on the method of removing a region including the defective portion present in the unprocessed sheet. However, for example, the sheet may be cut at the front side and backside of the defective portion by a rotary cutter, a cutting machine, an ultrasonic cutter or the like and the cut surfaces may be joined with each other by thermal welding or thermal fusion.

When an image is formed in the region including the joint part on the lengthy heat-sensitive transfer image receiving sheet by thermal transfer using a printer in the present invention, this causes such a disorder that image defects arise at the joint part, an ink ribbon is damaged or a thermal head is damaged. Therefore, the mark that enables the printer to detect the presence of the joint part is formed in the vicinity of the defective portions in order not to form an image on the joint parts. Examples of the mark are same marks as the examples of the mark formed in the vicinity of the defective portion.

As to the position at which the means that enables the printer to detect the presence of the joint part is to be disposed, the means is preferably formed at a position within 10 mm to 20 mm distant from the nearest joint part. The means is preferably formed at a position preceding the joint part in moving sheet at a digital photo printer.

Next, units detecting the means, such as the above mark, that enables a printer to detect the presence of the defective portion or the joint part are explained. Examples of the units include a bar code reader, a two-dimensional reader, a laser scanner, a linear measure, pen-shaped reader and microimage checker.

A printer provided with these detection means detects the mark just before printing, idly feeds the image receiving sheet of fixed length and cuts off the image receiving sheet including the defective portion or the joint part by a built-in cutter in the printer, whereby an image can be continuously formed while evading the a defective portion.

A printer provided with these detecting means idly feeds the joint part by detecting the mark just before printing and then cuts off the image receiving sheet by a built-in cutter in the printer, whereby an image is continuously formed while evading the a joint part.

As the printer to be used in the present invention, any printer may be used without any particular limitation insofar as it is a thermal transfer printer having the above detecting means and for example, a high-speed dye sublimation printer may be used. The printer in the present invention includes copying machines.

As the printer used in the present invention, any printer may be used without any particular limitation insofar as it has the above detecting means. For example, a high-speed sublimation type printer may be used.

In the present invention, the term “lengthy” means that the sheet has an unrolled length of, though not particularly limited to, preferably, 20 m or more, more preferably 30 m to 100 m and still more preferably 50 m to 90 m. Also, the width of the lengthy heat-sensitive transfer image receiving sheet is preferably 50 mm to 260 mm and more preferably 80 mm to 210 mm. The thickness of the lengthy heat-sensitive transfer image receiving sheet is preferably 160 μm to 250 μm and more preferably 180 μm to 230 μm.

Also, the lengthy heat-sensitive transfer image receiving sheet of the present invention is put in the state that it is wound roll-wise in light of storage and handling.

Preferred embodiments of the present invention will be explained with reference to the drawings: however, the present invention is not limited by these embodiments.

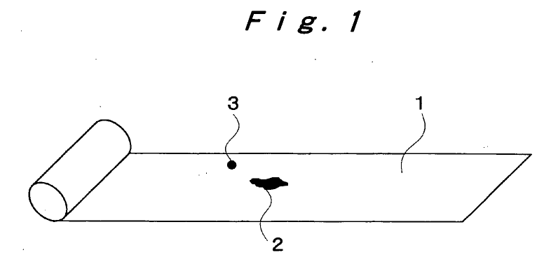

FIG. 1 is a schematically perspective view of one embodiment of the lengthy heat-sensitive transfer image receiving sheet of the present invention. A mark 3 that enables a printer to detect a defective portion 2 is disposed in the vicinity of the defective portion 2 present in a lengthy heat-sensitive image receiving sheet 1 most of which is wound roll-wise.

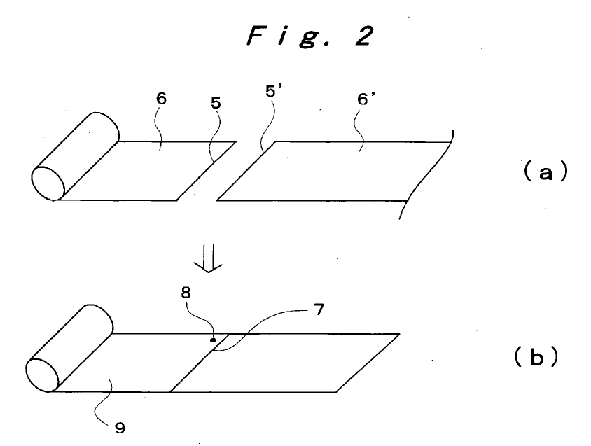

FIG. 2 is an explanatory drawing of a process of producing the lengthy heat-sensitive transfer image receiving sheet in one embodiment of this invention. As shown in FIG. 2(a), a roll-shaped unprocessed sheet 6 having an end part 5 and an unprocessed sheet 6′ having an end part 5′ are joined among these ends as shown in FIG. 2(b) to form a joint part 7 and a mark 8 is disposed in the vicinity of the joint part 7, to produce a lengthy heat-sensitive transfer image receiving sheet 9.

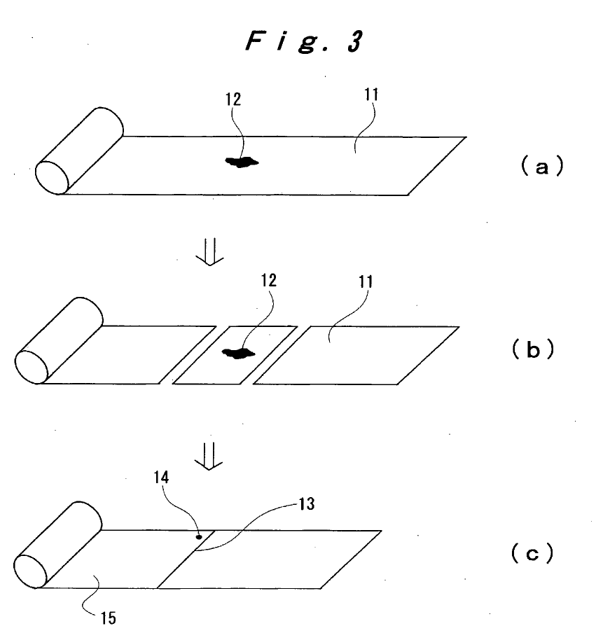

FIG. 3 is an explanatory view of a process of producing a lengthy heat-sensitive transfer image in another embodiment of this invention. A roll-shaped unprocessed sheet 12 having a defective portion 11 as shown in FIG. 3(a) is cut off and removed as shown in FIG. 3(b). Then, the front side and backside which are in contact with the removed region are joined with each other to form a joint part 13 and a mark 14 is disposed in the vicinity of the joint part 13 to produce a lengthy heat-sensitive transfer image receiving sheet 15.

### INDUSTRIAL APPLICABILITY

According to a heat-sensitive transfer image receiving sheet of the present invention, it is possible to produce a heat-sensitive transfer image receiving sheet in high productivity at low cost.

In addition, according to a heat-sensitive transfer image receiving sheet of the present invention, it is possible to form an image continuously by heat-sensitive transfer in a manner as not to use a defective portion or a joint part without carrying out additional operations even if it has the defective portion or the joint part.

In addition, according to a heat-sensitive transfer image receiving sheet of the present invention, it is possible to provide a lengthy heat-sensitive transfer image receiving sheet reproduced excluding a defective portion.

Having described our invention as related to the present embodiments, it is our intention that the invention not be limited by any of the details of the description, unless otherwise specified, but rather be construed broadly within its spirit and scope as set out in the accompanying claims.

This non-provisional application claims priority under 35 U.S.C. § 119 (a) on Patent Application No. 2005-241210 filed in Japan on Aug. 23, 2005 and Patent Application No. 2005-241215 filed in Japan on Aug. 23, 2005, each of which is entirely herein incorporated by reference.

1. A heat-sensitive transfer image receiving sheet that is provided in a form of a roll sheet, which comprises a mark formed in the vicinity of a defective portion, so that a printer detects the existence of the defective portion.

2. A heat-sensitive transfer image receiving sheet that is provided in a form of a roll sheet, which comprises a joint part and a mark formed in the vicinity of the joint part, so that a printer detects the existence of the joint part.

3. The heat-sensitive transfer image receiving sheet according to claim 2, wherein the joint part is a part in which an end part of an unprocessed sheet is joined with an end part of another unprocessed sheet.

4. The heat-sensitive transfer image receiving sheet according to claim 2, wherein the joint part is a part obtained by removing a region including a defective portion present in an unprocessed sheet and then by joining the cut surfaces which are in contact with the front side and backside of the removed region respectively with each other.
